(19) United States
(12) Patent Application Publication
(10) Pub. No.: US 2023/0195049 A1
(43) Pub. Date: Jun. 22, 2023

(54) WATCH BEZEL ENTIRELY OR PARTIALLY FORMING A TACTILE INTERFACE

(71) Applicant: ETA SA MANUFACTURE HORLOGÈRE SUISSE, Grenchen (CH)

(72) Inventor: Xavier STEHLIN, Cudrefin (CH)

(73) Assignee: ETA SA MANUFACTURE HORLOGÈRE SUISSE, Grenchen (CH)

(21) Appl. No.: 18/055,979

(22) Filed: Nov. 16, 2022

(30) Foreign Application Priority Data
Dec. 17, 2021 (EP) 21215635.0

(51) Int. Cl. G04G 21/08; G04B 19/18; G04R 60/08

(52) U.S. Cl. CPC G04G 21/08; G04B 19/18; G04R 60/08

(57) ABSTRACT

An electronic watch (1) including a case provided with a bezel (2) entirely or partially forming a tactile interface of the watch (1), the bezel (2) including an antenna circuit (10) of a communication module (6) and being provided with a body (5) including inner and outer faces (16, 17), the inner face (16) including a tactile control circuit (13) of a tactile control member (8) of this watch (1) and the outer face (17) including at least one tactile area (18a, 18b), the tactile control circuit (13) including at least one layer made of a conductive material forming an electrode (22) located beneath the at least one tactile area (18a, 18b).

### CROSS-REFERENCE TO RELATED APPLICATIONS

This application claims priority to European Patent Application No. 21215635.0 filed Dec. 17, 2021, the entire contents of which are incorporated herein by reference.

### TECHNICAL FIELD OF THE INVENTION

The invention relates to a bezel of an electronic watch entirely or partially forming a tactile interface, said bezel including an antenna circuit of a communication module and a tactile control circuit of a tactile control member of the watch.

### TECHNOLOGICAL BACKGROUND

Many portable electronic objects that could connect to communication networks are known in the prior art such as electronic watches which are provided with tactile interfaces conventionally arranged in the crystals of these. In general, such tactile interfaces are used to improve the interactivity of the watches and to simplify manipulations thereof in particular when these offer a large number of menus and functions.

In order to be able to connect to communication networks such as Bluetooth-type or geolocation-related networks, such electronic objects comprise communication means conventionally integrating an antenna. It is known that the optimum size of such an antenna depends directly on the wavelength of the emitted/received signal. Indeed, an antenna with an optimum length allows sending/receiving a signal in its entirety and at full power.

In these watches, the available space being limited, an antenna should have a suitable design in order to be integrated in the case of the watch. And if the watch integrates a radio communication means which operates over radio frequencies (such as 2.4 GHz or 1.5 GHz), the size of the product becomes critical with regards to the wavelength (120 mm and 200 mm).

Moreover, other constraints should also be taken into account because these watches include many metallic portions and because an antenna should be isolated therefrom.

In this context, one could understand that there is a need to find a solution, in particular one that does not have the drawbacks of the prior art.

### SUMMARY OF THE INVENTION

One of the aims of the invention is to provide an electronic watch, comprising a tactile interface and integrating an antenna circuit having an optimum length to send/receive a signal in its entirety and at full power and intended to be fitted into the case of this watch whose receiving volume is limited.

Another aim of the invention is to obtain an electronic watch whose aesthetics, energy consumption and manufacturing costs are not affected or barely affected by the integration of a tactile interface into a bezel of this watch.

Another aim of the invention is to obtain an electronic watch whose aesthetics, energy consumption and manufacturing costs are not affected or barely affected by the integration of a tactile interface and an antenna circuit into a bezel of this watch.

For this purpose, the invention relates to an electronic watch comprising a case provided with a bezel entirely or partially forming a tactile interface of said watch, said bezel comprising an antenna circuit of a communication module and being provided with a body comprising inner and outer faces, the inner face comprising a tactile control circuit of a tactile control member of this watch and the outer face comprising at least one tactile area, said tactile control circuit comprising at least one layer made of a conductive material forming an electrode located beneath said at least one tactile area.

In other embodiments:
said at least one layer made of a conductive material forming the electrode coats a portion of the inner face defined beneath said at least one tactile area of the outer face according to a technology of physical vapour deposition of the conductive material or a technology of micrometric-scale selective printing of the conductive material;
the layer made of a conductive material coating said portion of the inner face has a surface area which is smaller than the surface area of said tactile area of the outer face;
the inner face comprises several electrodes per tactile area;
the antenna circuit and the tactile control circuit are located within the bezel on either side of an axis of symmetry passing through the centre of the bezel;
the antenna circuit comprise first and second strands formed over a first portion of the inner face, each of said first and second strands having a proximal end and a distal end, and extending in parallel between their proximal and distal ends, the first and second strands being connected by their distal ends as well as at their proximal ends;
said at least one layer made of a conductive material forming the electrode is formed over a second portion of the inner face of the bezel;
the antenna circuit comprises a microcircuit connected to the first and second strands via an electrical connecting element;
the control circuit comprises a microcontroller connected to said at least one electrode via at least one an electrical connecting element;
the bezel is manufactured of at least one dielectric and/or electrically non-conductive material;
the watch is a smartwatch comprising such a bezel.

### BRIEF DESCRIPTION OF THE FIGURES

Other features and advantages of the present invention will appear more clearly from the following detailed description, made with reference to the appended figures listed hereinbelow:

FIG. 1 is a schematic representation of an electronic watch comprising a bezel entirely or partially forming a tactile interface of said watch, according to an embodiment of the invention;

FIG. 2A is a representation of the bezel comprising a wall provided with an inner face including a tactile control circuit formed in particular by electrodes, according to the embodiment of the invention;

FIG. 2B is a view at a larger scale of the portion E illustrated in FIG. 2A, according to the embodiment of the invention;

FIG. 3 is a schematic representation of the arrangement of the electrodes of the tactile control circuit and of an antenna circuit of said watch over the inner face of the bezel, according to the embodiment of the invention;

FIG. 4 is a schematic representation of the watch comprising a communication module and a tactile control member wherein the antenna circuit and the tactile control circuit are respectively arranged over the inner face of the wall of the bezel, according to the embodiment of the invention, and

FIG. 5 represents the bezel of the electronic watch showing in transparency the antenna circuit and the tactile control circuit, according to the embodiment of the invention.

### DETAILED DESCRIPTION OF THE INVENTION

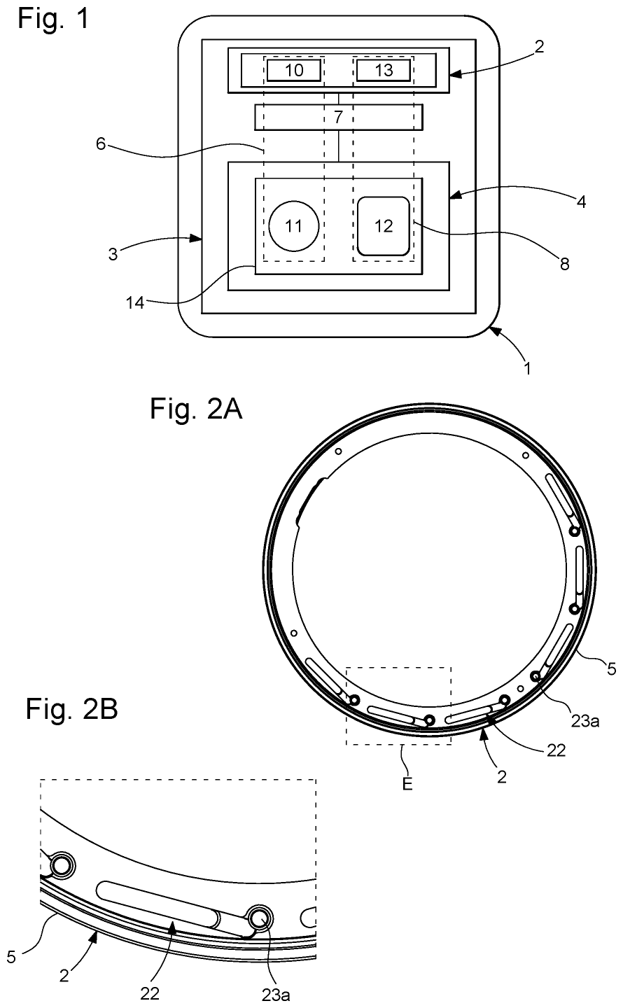

Referring to FIG. 1, the invention covers an electronic watch 1 such as a smartwatch.

In this context, such an electronic watch 1 is provided with a case 3 including a bezel 2 entirely or partially forming a tactile interface of said electronic watch 1 through which a wearer of said watch 1 could interact with the latter for example in order to control horological functions of this watch 1. This case 3 also includes a middle which could be made of metal (for example of steel, preferably stainless steel), of a synthetic material (for example of a composite material comprising a polymer matrix reinforced with fibres, typically carbon fibres) or of ceramic or else of at least one dielectric and/or electrically non-conductive material. The case 3 also comprises a back and a crystal which contribute to form with the middle, a hatch of this case 3. In particular, a display device 7 and an electronic device 4 of said electronic watch 1 are arranged within such a hatch.

The display device 7 includes display elements which could be analog such as hands and/or digital such as a LCD, LED or OLED screen. Such a display device 7 is located between the crystal and the electronic device 4, a spacer or flange could be arranged between the crystal and this display device 7.

As regards the electronic device 4, it comprises an electronic horological movement. It is configured to provide at least one piece of information having to be displayed on this display device 7. Non-exhaustively and without limitation, this electronic device 4 includes a communication module 6, a control module of the portable watch, an electrical energy accumulator in particular a battery as well as different sensors such as sensors involved in the determination of a geolocation, an altitude or a temperature of a location or in the determination of physiological, biometric, vital and/or behavioural parameters of the wearer of the electronic watch 1.

It should be noted that in this configuration, the control module enables the wearer of such an electronic watch 1 to be able to interact with the latter in particular by being able to activate/deactivate/select different functions—for example horological functions—that could be implemented by this electronic watch 1. This control module comprises a tactile control member 8 and in some alternatives other control members such as push-pieces or buttons arranged on the middle.

In the electronic device 4, the communication module 6 comprises an antenna circuit 10 connected to a microcircuit 11, and the tactile control member 8 comprises a microcontroller 12 connected to a tactile control circuit 13. As we will see later on, the antenna circuit 10 and the control circuit 13 are arranged over an inner face 16 of the bezel 2, the latter entirely or partially forming a tactile interface of said electronic watch 1.

Preferably, such a bezel 2 is fastened on the middle of the case 3. This bezel 2 may be a part removably fastened on the middle or else a part integrally made with this middle. It may consist of a monolithic part or conversely of a part made into two portions connected together in a reversible and/or tight manner. The bezel 2 comprises a body 5 provided with the aforementioned inner face 16 and with an outer face 17. The outer face 17 is a face of this bezel 2 visible to the wearer which could be manipulated at first and second tactile areas 18a, 18b defined over this face. The bezel 2 may comprise a graduation over its outer face 17. In the illustrated example, the graduation comprises figurative indexes 24 which are in the form of numerals (preferably Arabic numerals).

For the antenna circuit 10 and the control circuit 13 to operate effectively and/or optimally, this bezel 2 is made of at least one dielectric and/or electrically non-conductive material. Said at least one material allows contributing to the achievement of the capacitive effect of the tactile control member 8. This material is also involved in not deteriorating the radiation of the antenna circuit 10, enlarging its electric length and improving its efficiency with regards to its physical size. For example, such a material may be a polymer, titanium or a ceramic, or any other synthetic material. It should be noted that it is possible that the entire body 5 of this bezel 2 is not made of this material type but only portions of this body 5:
within which are arranged the antenna circuit 10 and the control circuit 13 are made of this material, and/or
comprising the first and second tactile areas 18a, 18b of the external face of the bezel 2 are made of this material.

Thus, as we have mentioned before, such a bezel 2 is located at the middle and clasps the crystal. It may consist of a rotating bezel or a fixed bezel. The bezel 2 may also be arranged in the case 3 so as to form one-piece with the middle i.e. a middle-bezel. In this variant, the middle and the bezel then have an outer face 17 which is the face visible to the wearer of this watch 1.

The body 5 of this bezel 2 may comprise arrangements intended to provide access to a printed circuit 14 of the electronic device 4 including the microcontroller 12 of the control member 8 and the microcircuit 11 of the communication module 6. Thus, such arrangements offer the possibility of forming a passage in this body 5 of the bezel 2 in order to connect the control circuit 13, in particular the electrodes 22, and the antenna circuit 10 respectively to the microcontroller 12 of the control member 8 and to the microcircuit 11 of the communication module 6.

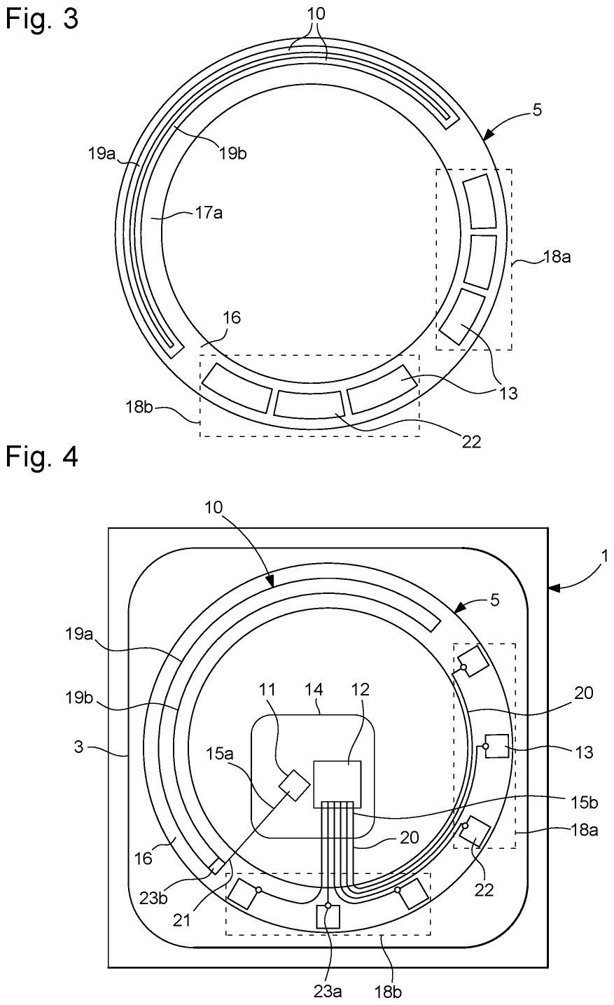

Referring to FIGS. 2A to 4, the control member 8 comprises the microcontroller 12 which is connected to the tactile control circuit 13. Such a tactile control circuit 13 comprises at least one layer made of a conductive material forming an electrode 22 located beneath one of the first and second tactile areas 18a, 18b of the outer face 17 of the body 5 of the bezel 2. In other words, each electrode 22 is formed by the layer made of a conductive material or is in the form of such a layer. Such an electrode 22 has a circular or parallelepiped or triangular shape. Hence, this layer made of a conductive material forming the electrode 22 coats a portion of the inner face 16 defined beneath either one of the tactile areas of the outer face 17. It should be noted that the layer made of a conductive material coating said portion of the inner face 16 has a surface area which is smaller than the surface area of each tactile area of the outer face 17.

This electrode 22 may comprise a connection terminal 23a intended to link/connect it to the microcontroller 12 of the control member 8. In this configuration, the control circuit 13 comprises an electrical connecting element 20 able to achieve the connection between each electrode 22 and the microcontroller 12. This connecting element 20 is able to cooperate with at least one electrical track 15b of the printed circuit 14 of the electronic device 4 comprising the microcontroller 12. In this manner, each electrode 22 is thus connected to the microcontroller 12 from this connecting element 20 and said at least one electrical track 15b. Finally, one could notice that the tactile control circuit 13 preferably comprises as many connecting elements 20 as electrodes 22 that the inner face 16 of the bezel 2 comprises.

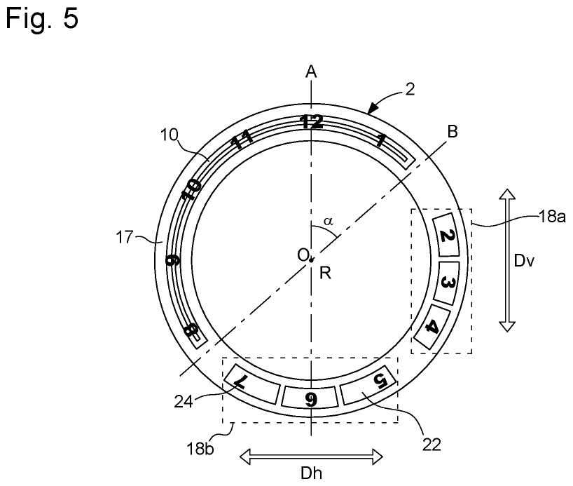

Referring to FIGS. 2A to 5, the tactile control member 8 comprises six electrodes 22 distributed over the inner face 16 of the body 5 of the bezel 2. More specifically, these electrodes 22 are applied/deposited over this inner face 16 so as to define/form two distinct tactile areas 18a, 18b over the outer face 17 of this bezel 2, these two tactile areas 18a, 18b thus forming the tactile interface of the electronic watch 1. In this configuration, the inner face 16 comprises several electrodes 22 per tactile area 18a, 18b. The first tactile area 18a comprises three electrodes 22 respectively arranged beneath the indexes 24 two, three and four defined over the outer face 17 of the bezel 2. The second tactile area 18b also comprises three electrodes 22 respectively arranged beneath the indexes 24 five, six and seven defined over this outer face 17 of the bezel 2. In this configuration, the first tactile area 18a enables the wearer of the watch 1 to interact with the latter by performing a movement in particular a “vertical movement” (referenced Dv in FIG. 5) of an accessory such as a stylus or a tip of one of his limbs such as a finger over this first area 18a. As regards the second tactile area 18b, it enables the wearer of the watch 1 to interact with the latter by performing a movement in particular a “horizontal movement” (reference Dh in FIG. 5) of such an accessory or of the tip of one of his limbs over this area 18b. The vertical movement describes a trajectory which is substantially parallel or parallel to an axis of symmetry A of the bezel 2 passing through the centre O of this bezel 2 and this trajectory being also substantially perpendicular or perpendicular to an axis of revolution R of this bezel 2. As regards the horizontal movement, it describes a trajectory which, in turn, is substantially perpendicular or perpendicular to this axis A (or to the trajectory described by the vertical movement) and also perpendicular to the axis of revolution R of this bezel 2. Such an axis A separates the bezel 2 into two equal parts/portions while connecting the indexes 24 twelve and six present over the outer face 17 of this bezel 2.

In the electronic device 4, the communication module 6 is able to enable the connection of the electronic watch 1 to a Bluetooth-type communication network. In other words, the communication module 6 is configured to communicate according to a Bluetooth-type protocol. Alternatively, this communication module 6 could be able to enable the connection of the watch 1 to a GNSS (Geolocation and Navigation Satellite System) satellite location network, such as the GPS (Global Positioning System), Glonass or Galileo. This communication module 6 comprises the antenna circuit 10 connected to the microcircuit 11.

In the present embodiment, such an antenna circuit 10 is comprised over the inner face 16 of the body 5 of the bezel 2. This antenna circuit 10 comprises first and second strands 19a, 19b each having a proximal end and a distal end, and extending in parallel between their proximal and distal ends. In this antenna circuit 10, the architecture with two strands in parallel allows enlarging the frequency band (100 MHz), necessary for example to communicate over a Bluetooth-type communication network (2.4 GHz). In this antenna circuit 10, the first and second strands 19a, 19b are connected by their distal ends as well as at their proximal ends. In this configuration, the antenna circuit 10 extends essentially according to a circular arc trajectory including two strands 19a, 19b arranged in parallel over the inner face 16 which follows this trajectory. This antenna circuit 10 also comprises an electrical connecting element 21 connected to a connection terminal 23b comprised over the inner face 16 connected to these proximal or distal ends. This electrical connecting element 21 is able to cooperate with at least one electrical track 15a of the printed circuit 14 of the electronic device 4 comprising the microcircuit 11 of the communication module 6. In this manner, the antenna circuit 10 is connected to this microcircuit 11 from this said at least one electrical connecting element 21 and from said at least one electrical track 15a.

In this configuration, the antenna circuit 10 and the tactile control circuit 13 are located within the bezel 2 on either side of an axis of symmetry B passing through the centre O of the bezel 2 and which is substantially perpendicular or perpendicular to the axis of revolution R of this bezel 2. This axis referenced B separates the bezel 2 into two parts/portions and forms an angle α with the axis A which is comprised between 30 and 40 degrees and which is preferably 36 degrees. Thus, the antenna circuit 10 and the tactile control circuit 13 are entirely or partially made over distinct portions of the inner face 16 of the body 5 of the bezel 2. These two portions are separated by the axis of symmetry B. More specifically, the inner face 16 of the bezel 2 comprises two portions having substantially the same surface area or with the same surface area. This first portion comprises the first and second strands 19a, 19b as well as the connection terminal 23b of this antenna circuit 10. In turn, the second portion comprises the electrodes 22.

It should be further noted that the control circuit 13 and the antenna circuit 10 could be made over this inner face 16 of the body 5 of the bezel 2 according to a technology of physical vapour deposition of a conductive material or a technology of micrometric-scale selective printing of this conductive material comprising a conductive ink. Technologies of screen-printing with silver over an inner face 16 made of polyester or with copper over an inner face 16 made of polyimide could also be considered.

It goes without saying that the present invention is not limited to the embodiment that has just been described and that various simple modifications and variants could be considered by a person skilled in the art without departing from the scope of the invention as defined by the appended claims.

1. An electronic watch (1) comprising:
a case; and
a bezel (2) entirely or partially forming a tactile interface of said watch (1),
wherein said bezel (2) comprises an antenna circuit (10) of a communication module (6) and is provided with a body (5) comprising inner and outer faces (16, 17), the inner face (16) comprising a tactile control circuit (13) of a tactile control member (8) of the watch (1) and the outer face (17) comprising at least one tactile area (18a, 18b), said tactile control circuit (13) comprising at least one layer made of a conductive material forming an electrode (22) located beneath said at least one tactile area (18a, 18b).

2. The electronic watch (1) according to claim 1, wherein said at least one layer made of a conductive material forming the electrode (22) coats a portion of the inner face (16) defined beneath said at least one tactile area of the outer face (17) according to a technology of physical vapour deposition of the conductive material or a technology of micrometric-scale selective printing of the conductive material.

3. The electronic watch (1) according to claim 1, wherein the layer made of a conductive material coating said portion of the inner face (16) has a surface area which is smaller than the surface area of said tactile area of the outer face (17).

4. The electronic watch (1) according to claim 1, wherein the inner face (16) comprises several electrodes (22) per tactile area.

5. The electronic watch (1) according to claim 1, wherein the antenna circuit (10) and the tactile control circuit (13) are located within the bezel (2) on either side of an axis of symmetry (B) passing through the centre of the bezel (2).

6. The electronic watch (1) according to claim 1, wherein the antenna circuit (10) comprise first and second strands (19a, 19b) formed over a first portion of the inner face (16), each of said first and second strands (19a, 19b) having a proximal end and a distal end, and extending in parallel between their proximal and distal ends, the first and second strands (19a, 19b) being connected by their distal ends as well as at their proximal ends.

7. The electronic watch (1) according to claim 1, wherein said at least one layer made of a conductive material forming the electrode (22) is formed over a second portion of the inner face (16) of the bezel (2).

8. The electronic watch (1) according to claim 1, wherein the antenna circuit (10) comprises a microcircuit (11) connected to the first and second strands (19a, 19b) via an electrical connecting element (21).

9. The electronic watch (1) according to claim 1, wherein the control circuit (13) comprises a microcontroller (12) connected to said at least one electrode (22) via at least one an electrical connecting element (20).

10. The electronic watch (1) according to claim 1, wherein the bezel (2) is manufactured of at least one dielectric and/or electrically non-conductive material.

11. The electronic watch (1) according to claim 1, wherein the watch is a smartwatch comprising the bezel (2).
